(19) United States
(12) Patent Application Publication
(10) Pub. No.: US 2024/0156298 A1
(43) Pub. Date: May 16, 2024

(54) SYSTEM AND METHOD FOR DISPENSING A PORTION OF A HOT MILK-CONTAINING BEVERAGE COMPONENT OR BEVERAGE, AND USE OF A THICK FILM HEATER

(71) Applicant: FrieslandCampina Nederland B.V., Amersfoort (NL)

(72) Inventors: Niklaus HUGI, Ittigen (CH); Wiebe Nicolaas VAN DRUTEN, Zeewolde (NL); Diana Marcela CARRERO PINTO, Utrecht (NL); Willibrorda Antonia Maria VAN DE HEIJNING, Wolfheze (NL); Regina GIOVANI, Lunteren (NL)

(73) Assignee: FrieslandCampina Nederland B.V., Amersfoort (NL)

(21) Appl. No.: 18/517,499

(22) Filed: Nov. 22, 2023

Related U.S. Application Data
(63) Continuation of application No. PCT/NL2022/050291, filed on May 25, 2022.

(30) Foreign Application Priority Data
May 26, 2021 (EP) 21175956.8

(51) Int. Cl. A47J 31/54; A47J 31/40; A47J 31/41; A47J 31/52

(52) U.S. Cl. CPC A47J 31/545; A47J 31/402; A47J 31/41; A47J 31/5253; A47J 2202/00

(57) ABSTRACT

System (1) for intermittently dispensing portions of a hot milk-containing beverage component or beverage, comprising a flow channel (30) extending from a water inlet (31) to a dispensing outlet (32), the flow channel (30) being provided with a milk concentrate inlet (33) upstream of the dispensing outlet (32) and a thick film heater (18) upstream of the milk concentrate inlet (33), wherein the system comprises: water temperature determination means (34) configured to determine, e.g. estimate and/or measure, a water temperature at or upstream of a water inlet (35) of the thick film heater (18); and a controller (36) configured to control the thick film heater (18) in dependence of a water temperature determined by the water temperature determination means (34).

This application is a continuation of International Patent Application No. PCT/NL2022/050291 filed May 25, 2022, which application claims the benefit of European Patent Application No. 21175956.8 filed on May 26, 2021, both of which are incorporated herein by reference in their entireties.

The invention concerns a system and method for dispensing a portion of a hot milk-containing beverage component or beverage, the beverage for example being hot coffee.

Such systems and methods are as such generally known. In a known system and method, liquid milk concentrate is mixed with a flow of hot water to form hot milk. The hot water is supplied from a buffer unit (e.g., a boiler) which electrically heats a buffer volume of water, the buffer volume for example being supplied from a general water tap. An advantage of such a hot water supply is that the water can be heated to a desired temperature without exceeding a maximum electrical power consumption e.g., of a mains outlet. However, boiler solutions are bulky, can consume a lot of energy and may not be capable to deliver water of a desired temperature after several servings have been carried out.

Another known heating solution includes a thermoblock. A disadvantage is that the heating is relatively slow, so that a user may have to wait for an undesired amount of time before the hot beverage can be dispensed. Another disadvantage is that the ongoing power consumption of known heater solutions effectively limits the power consumption of other electrically powered components associated with the beverage dispensing. The other electrically powered components are for example associated with coffee dispensing in a same beverage dispensing system. Depending on a power management configuration of such a system, power for heating water for milk may be available only to the extent that it is not consumed by coffee-related components. For these reasons, the integration of milk dispensing and coffee dispensing in a combined system has been found difficult. Also, difficulties have arisen in case of integration in coffee machines that have highly varying internal temperatures, or high internal temperatures (e.g., over 40° C.), due to heat generation of respective coffee brewing components.

US2021/0145205A1 discloses a relatively complex milk powder brewing machine, having an improved cooling effect. The machine has a mixing bin, a milk powder box, a water storage tank, and a constant-temperature bin. The constant temperature has a PTC heater at its bottom for heating the water in that bin, as well as respective NTC temperature sensors. Once the detected temperature in the constant-temperature bin is excessively low, the PTC heater is immediately initiated to heat the water, thereby always keeping the constant temperature of the water in the constant-temperature bin. In addition, the machine includes a thick-film heater and downstream spiral cooling pipes. The first one of these spiral pipes is provided with a temperature detector. The thick-film heater is utilized to rapidly heat water delivered into the thick-film heater to a temperature of 90-100° C. The heated water is cooled and passed to the bin.

EP1380243 provides a machine for the heating of a liquid in a beverage machine comprising at least one set of at least two resistors, for transferring energy to a flow of water provided from an upstream cold water tank.

An object of the present invention is to provide an improved system for intermittently dispensing portions of a hot milk-containing beverage component or beverage, wherein in particular waiting time is reduced and/or wherein power consumption associated with dispensing hot milk for a portion is more easily combined with power consumption needs of e.g., coffee dispensing and/or wherein overheating of water is more easily prevented.

To that end, a first aspect of the invention provides a system for intermittently dispensing portions of a hot milk-containing beverage component or beverage. According to the first aspect the system comprises a flow channel extending from a water inlet to a dispensing outlet, the flow channel being provided with a milk concentrate inlet upstream of the dispensing outlet and a thick film heater upstream of the milk concentrate inlet. According to the first aspect the system comprises water temperature determination means configured to determine, e.g., estimate and/or measure, a water temperature at or upstream of a water inlet of the thick film heater. According to the first aspect the system comprises a controller configured to control the thick film heater in dependence of a water temperature determined by the water temperature determination means.

Such a combination of a thick film heater and controller enables precise, fast and efficient water heating, in particular under varying conditions such as varying heater power availability and/or a varying water inlet temperature. Power consumption for such heating can be substantially limited to a well-defined time period around the time of dispensing, thus enabling easier integration with other power consumers and/or power managers such as those of coffee machines. Overheating can be effectively prevented, e.g., by limiting the heating by the heater depending on the determined water temperature. Moreover, in this way, reliable dispensing results without overheating can be achieved in case of relatively high internal temperature variations of the system, e.g., a coffee machine that can have a relatively high internal operational temperature of at least 40° C. or even at least 50° C. at ambient room temperature of 20° C.

For example, the system includes a single (only one) heater, the heater being the thick film heater, so that a compact, energy efficient and reliable system can be achieved.

Thick film heaters are known as such in various forms (see e.g., https://en.wikipedia.org/wiki/Heating_element) and can advantageously be combined with such a controller in a system for intermittently dispensing portions of a hot milk-containing beverage component or beverage. The thick film heater preferably provides a section of said flow channel, the channel extending between the water inlet of the heater and a water outlet of the heater.

According to an embodiment, in a first heating mode the controlling of the heater by the controller may be substantially independent of the determined temperature, wherein in a subsequent second heating mode the controlling by the controller is dependent on the determined temperature.

The first heating mode may include a pre-heating period wherein less or no water flows through the heater. In the first mode the controller may be configured to control the heater at a fixed and/or a varying, e.g., time-varying, heating level and/or power level.

It has been found that particularly fast and precise water heating can be provided in this way. For example, the second mode is only activated after a predetermined time of heating in the first mode, wherein the first mode enables faster initial heating and the second mode enables more precise control.

According to an embodiment, the system, for example the controller, may be configured to power down the thick film heater at a predetermined heater deactivation time before the system stops feeding water to the flow channel.

More efficient power consumption can thus be promoted, wherein a buildup of excess hot water, e.g., in the heater, can be reduced.

According to an embodiment, the water temperature determination means may be configured to measure a water temperature at or downstream of a water outlet of the thick film heater and to estimate the water temperature at or upstream of the water inlet of the thick film heater based on at least the measured temperature at or downstream of the water outlet.

Good water temperature control can thus be obtained with a relatively low number of temperature sensing components.

According to an embodiment, the controller may be configured to control the thick film heater during dispensing of one of the portions in dependence of a first water temperature which is estimated, by the water temperature determination means, based on at least a second water temperature at or downstream of the water outlet which second water temperature is measured, by the water temperature determination means, during dispensing of one or more previous portions of the portions.

For example, a water temperature measured at a water outlet of the heater during dispensing of one portion may be used to estimate a water temperature at the water inlet of the heater for dispensing a subsequent portion. Such estimating preferably takes into account how much time has passed between the dispensing of said portions, wherein for example the estimate is closer to the measured value when less time has passed.

According to an embodiment, the system may be configured to receive a milk concentrate container, in particular of a bag-in-box type, for supplying milk concentrate to the milk concentrate inlet.

Milk concentrate can thus be supplied in a particularly hygienic and user friendly way.

According to an embodiment, the system may comprise a valve actuator for actuating a valve member of the received milk concentrate container, which valve member during use regulates a flow of milk concentrate to the milk concentrate inlet of the flow channel, wherein the controller is configured to control the valve actuator for regulating the flow of milk concentrate.

Automatic and hygienic control of the supply of milk concentrate can thus be enabled, wherein for example control of the valve actuator is coordinated with control of the heater and/or vice versa, the valve actuator and the heater for example being controller by a same controller. Such a valve actuator in a system for dispensing a hot milk containing beverage is known as such, see for example WO2014/069993A1, and can advantageously be combined with a system of the present invention.

The water temperature determination means may comprise a temperature sensor, in particular a negative temperature coefficient (NTC) type thermistor, arranged at a water outlet of the thick film heater.

Reliable temperature measurement at the water outlet of the heater can thus be provided.

In a preferred embodiment, the hot milk-containing beverage component or beverage may comprise coffee, wherein the system further comprises coffee dispensing means for dispensing coffee for the portions.

An improved integrated system for dispensing beverages which contain both coffee and milk can thus be provided, wherein in particular power management is improved. Examples of such beverages include: café au lait, cappuccino, cortado, flat white, latte, latte macchiato and macchiato.

A second aspect provides a method of dispensing a portion of a hot milk-containing beverage component or beverage, for example a method utilizing a system according to the invention. According to the second aspect the method comprises: feeding water through a flow channel; heating the water in the flow channel by a thick film heater; and feeding milk concentrate to the heated water in the flow channel. According to the second aspect the method comprises determining, e.g., estimating and/or sensing, a water temperature at or upstream of a water inlet of the thick film heater, and controlling the heating by the heater in dependence of the determined water temperature.

Such a method can provide above-mentioned advantages.

In a first heating mode the controlling may be substantially independent of the determined temperature, wherein in a subsequent second heating mode the controlling is dependent on the determined temperature.

The method may comprise comprising powering down the heater while water flows through the heater.

The determining of the water temperature at or upstream of the water inlet of the thick film heater may comprise: sensing a water temperature at or downstream of a water outlet of the thick film heater, for example during a dispensing of a previous portion of the hot milk-containing beverage component or beverage, and subsequently estimating the water temperature at or upstream of the water inlet based on at least the sensed water temperature at or downstream of the water outlet.

The method may comprise actuating a valve member of a milk concentrate container for regulating the feeding of milk concentrate.

A third aspect provides use of a thick film heater for heating water intermittently flowing through a flow channel which water is mixed with a milk concentrate downstream of the heater, whereby hot milk is formed for dispensing portions of a hot milk-containing beverage component or beverage.

Such use of a thick film heater provides above-mentioned advantages.

A fourth aspect, which may be combined with one or more of the above-mentioned other aspects, provides a system for intermittently dispensing portions of a hot milk-containing beverage component or beverage. According to the fourth aspect the system comprises a flow channel extending from a water inlet to a dispensing outlet, the flow channel being provided with a milk concentrate inlet upstream of the dispensing outlet and a thick film heater upstream of the milk concentrate inlet. According to the fourth aspect the system comprises water temperature determination means configured to determine, e.g., estimate and/or measure, a property, in particular a temperature, of water in the flow channel. According to the fourth aspect the system includes a controller configured to control the thick film heater, wherein in a first heating mode the controlling by the controller is substantially independent of the determined property, wherein in a subsequent second heating mode the controlling by the controller is dependent on the determined property.

Such a combination of a thick film heater and controller enables precise, fast and efficient water heating, in particular under varying conditions such as varying heater power availability and/or a varying water inlet temperature. Power consumption for such heating can be substantially limited to a well-defined time period around the time of dispensing, thus enabling easier integration with other power consumers and/or power managers such as those in coffee machines. Overheating can be effectively prevented, e.g., by limiting the heating by the heater depending on the determined water temperature.

The first heating mode may include a pre-heating period wherein less or no water flows through the heater. In the first mode the controller may be configured to control the heater at a fixed and/or a varying, e.g., time-varying, heating level and/or power level.

It has been found that particularly fast and precise water heating can be provided in this way. For example, the second mode is only activated after a predetermined time of heating in the first mode, wherein the first mode enables faster initial heating and the second mode enables more precise control.

A fifth aspect, which may be combined with one or more of the above-mentioned other aspects, provides a system for intermittently dispensing portions of a hot milk-containing beverage component or beverage. According to the fifth aspect the system comprises a flow channel extending from a water inlet to a dispensing outlet, the flow channel being provided with a milk concentrate inlet upstream of the dispensing outlet and a thick film heater upstream of the milk concentrate inlet. According to the fifth aspect the system is configured to power down the thick film heater at a predetermined heater deactivation time before the system stops feeding water to the flow channel.

Such a configuration of a system with a thick film heater enables precise, fast and efficient water heating, in particular under varying conditions such as varying heater power availability and/or a varying water inlet temperature. Power consumption for such heating can be substantially limited to a well-defined time period around the time of dispensing, thus enabling easier integration with other power consumers and/or power managers such as those in coffee machines. Overheating can be effectively prevented, in particular by deactivating the heater prior to stopping the feeding of water. Buildup of excess hot water in and/or around the heater can be effectively prevented in this way substantially without affecting precise temperature control.

A sixth aspect, which may be combined with one or more of the above-mentioned other aspects, provides a method of dispensing a portion of a hot milk-containing beverage component or beverage. According to the sixth aspect the method comprises: feeding water through a flow channel; heating the water in the flow channel by a thick film heater; and feeding milk concentrate to the heated water in the flow channel. According to the sixth aspect the method comprises determining, e.g., estimating and/or sensing, a property, in particular a temperature, of the water, and controlling the heating, wherein in a first heating mode the controlling is substantially independent of the determined property, wherein in a subsequent second heating mode the controlling is dependent on the determined property.

Such a method provides above-mentioned advantages.

A seventh aspect, which may be combined with one or more of the above-mentioned other aspects, provides a method of dispensing a portion of a hot milk-containing beverage component or beverage. According to the seventh aspect the method comprises: feeding water through a flow channel; heating the water in the flow channel by a thick film heater; and feeding milk concentrate to the heated water in the flow channel. According to the sixth aspect the method comprises powering down the heater while water flows through the heater.

Such a method provides above-mentioned advantages.

For example, according to an embodiment, the method can include the following modes of operation:
1) a preheat mode, wherein the heater is powered to a predetermined high heating level (preferably a maximum heating level providing a full heating capacity of the heater), without water flowing through the heater, wherein optionally a duration of the first mode is calculated based on an estimated heating power of the heating (for example based on a previous dispensing);
2) a flow startup mode, wherein water flows through the heater, and wherein the heater is powered to a second heating level that is lower than said predetermined high heating level (the second heating level in particular being smaller than said maximum heating level so that it does provides only part of the heating capacity of the heater, the second heating level being larger than zero), wherein the second heating level is preferably calculated based on an estimated water inlet temperature and an estimated heater power;
3)—a control phase mode, during which a controller controls the thick film heater in dependence of a water temperature determined by the water temperature determination means, wherein preferably a heater power level is controlled to achieve a desired or predetermined water outlet temperature, for example based on a measured outlet temperature; and
4).—a pre-stop mode, during which the thick film heater is powered down at a predetermined heater deactivation time after which water remains flowing through the heater for a certain final water flow duration (the water flow being stopped at the end of the final water flow duration).

In embodiments of one or more the aspects, the system is configured to effect, and/or the method comprises effecting, in particular during dispensing, a flow rate of water through the thick film heater of at least 100 ml per minute, preferably at least 150 ml per minute, more preferably at least 200 ml per minute, in particular 250 ml minute or more, for example in the range of 250 to 450 ml per minute. Advantageously, a relatively rapid dispensing of a desirably hot beverage can thus be realized.

In the following the invention will be explained using exemplary embodiments and drawings. The drawings are schematic and merely show examples. In the drawings corresponding elements have been provided with corresponding references signs. In the drawings:

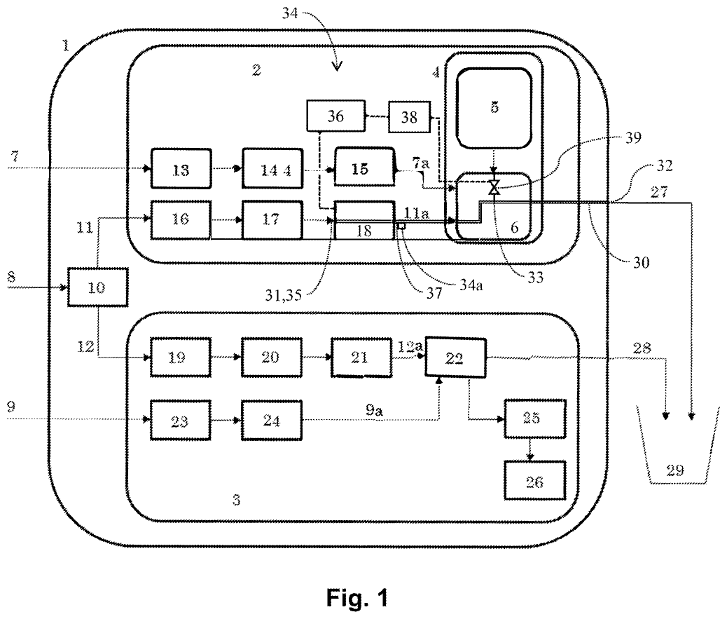

FIG. 1 highly schematically shows an exemplary beverage dispensing system 1 as well as features of an exemplary method;

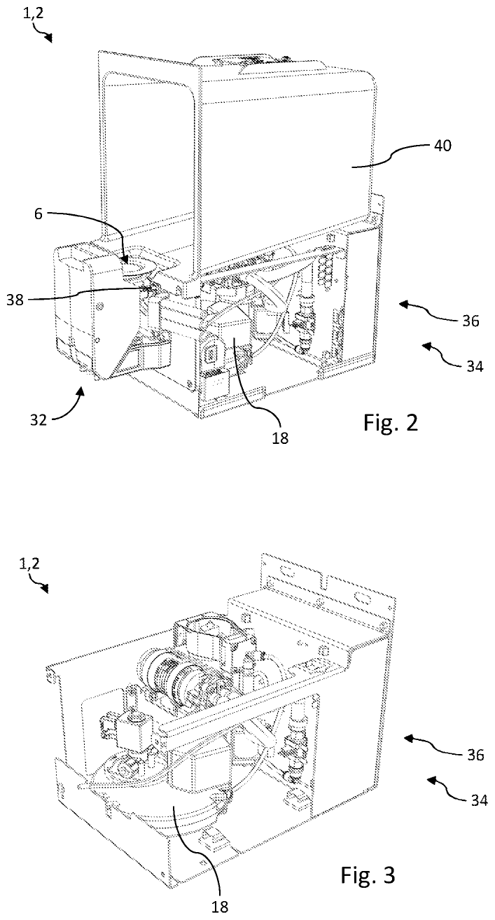

FIG. 2 shows a perspective front view of a milk section of the system of FIG. 1;

FIG. 3 shows a partly opened perspective front view of the milk section of FIG. 2;

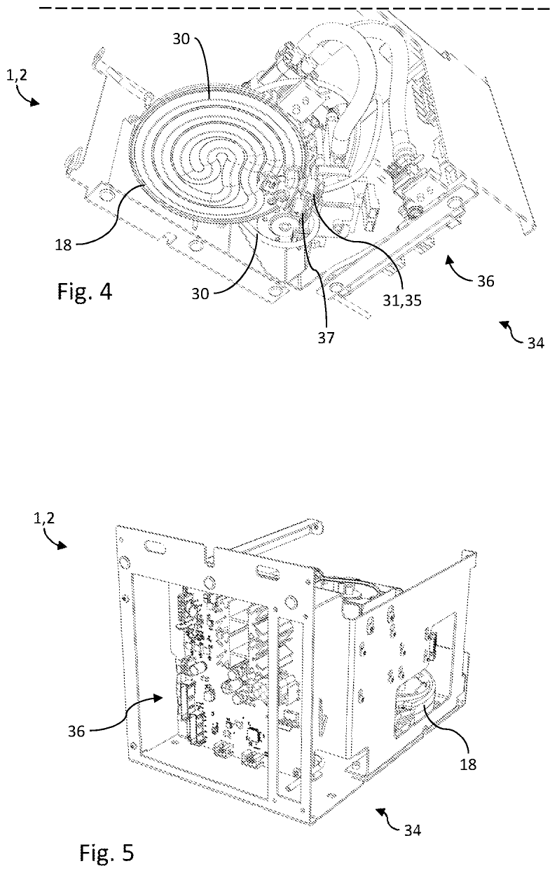

FIG. 4 shows a further partly opened perspective view of the milk section of FIG. 3;

FIG. 5 shows a partly opened perspective back view of the milk section of FIG. 3; and

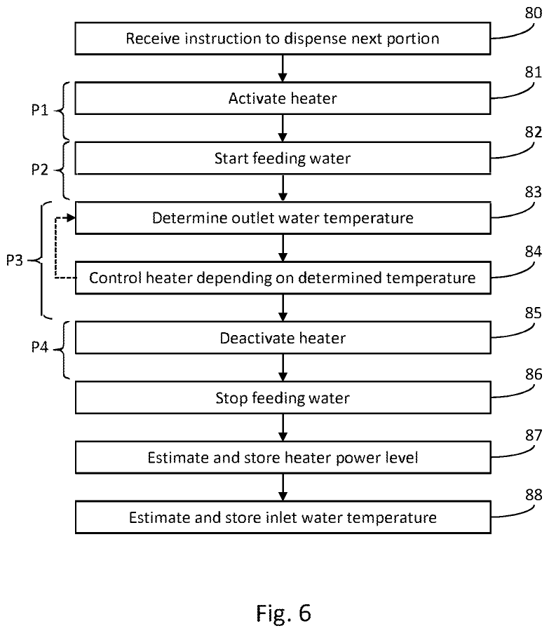

FIG. 6 shows a flow chart of an exemplary method of dispensing a portion of a hot milk-containing beverage component or beverage.

FIGS. 1-5 show an example of a system 1 for intermittently dispensing portions of a hot milk-containing beverage component or beverage. Each said portion may be e.g., in the range of about 10 ml to 500 ml of a total volume, for example 90 to 350 ml of total volume, or another range.

The present system 1 comprises a flow channel 30 extending from a water inlet 31 to a dispensing outlet 32, the flow channel 30 being provided with a milk concentrate inlet 33 upstream of the dispensing outlet 32 and a (e.g., single) thick film heater 18 upstream of the milk concentrate inlet 33. The system 1 comprises water temperature determination means 34 configured to determine, e.g., estimate and/or measure, a water temperature at or upstream of a water inlet 35 of the thick film heater 18. The system also comprises a controller 36 configured to control the thick film heater 18 in dependence of a water temperature determined by the water temperature determination means 34.

The water temperature determination means 34 here are for example at least partly included in the controller 36. The water temperature determination means 34 can comprise one or more sensors as will be explained in more detail elsewhere in this description.

FIG. 1 shows the exemplary system 1 as comprising a milk section 2 and a brewing section 3.

In an exemplary use of said system 1, a water flow 8 enters the system 1. The water flow 8 can e.g., be a flow of relatively cold (e.g., unheated or low temperature) water. For example, the water flow 8 can be provided by a water source (not shown), e.g., a water tap and/or a respective water conduit.

The water flow can pass through an optional valve 10 and can be split into a first water flow 12 and a second water flow 11. The first water flow 12 enters brewing section 3 and successively passes water pump 19, water flow meter 20 and first water heater 21 resulting in first hot water flow 12a. Bean hopper 23 that forms part of brewing section 3 is fed with coffee bean supply 9. The coffee beans from bean hopper 23 are ground in grinder 24 and ground coffee 9a is passed into brewing unit 22. The first hot water flow 12a is also passed into brewing unit 22, where coffee 28 is prepared.

Meanwhile, the second water flow 11 enters the milk section 2 and successively passes water pump 16, water flow meter 17 and second water heater 18 resulting in second hot water flow 11a that enters mixing device 6 of milk concentrate container 4. Here the second water heater 18 is a thick film heater 18.

In use of the system 1, as shown in FIG. 1, an optional air flow 7 can enter the system 1 in milk section 2 and after passing through particle filter 13 it is pressurized in air pump 14, after which the pressurized air 7a enters the mixing device 6 of milk concentrate container 4 via air sealed connector 15 that ensures a releasable, airtight connection with mixing device 6. Liquid milk concentrate from liquid milk concentrate supply 5 enters the mixing device 6. In mixing device 6 the liquid milk concentrate is first mixed with the second hot water flow 11a resulting in a hot milk stream before pressurized air 7a is introduced in this hot milk flow resulting in milk froth 27.

Coffee 28 and milk froth 27 are eventually dispensed in receptacle 29.

The coffee cake resulting from brewing coffee in brewing unit 22 is collected in cake tray 25 whilst any water contained in the cake is collected in drip tray 26.

FIGS. 2-5 show a further embodiment of parts of the milk section 2 of the exemplary system 1. Parts of the milk section 2 here form a module which can be integrated in the overall system 1. While in the example of FIG. 1 the milk section 2 is integrated with a brewing section 3 for coffee, it will be appreciated that this is not always necessary. Thus, a system 1 according to the invention need not necessarily include such a brewing section 3.

In the example, in a first heating mode the controlling by the controller 36 can be substantially independent of the determined temperature, wherein in a subsequent second heating mode the controlling 84 by the controller 36 is dependent on the determined temperature. Reference is made here to FIG. 6 which shows steps of an exemplary method which will be described in more detail elsewhere in this description. The steps include such controlling 84 of the heater depending on the determined temperature.

In the example, the system 1, for example the controller 36, can be configured to power down 85 the thick film heater 18 at a predetermined heater deactivation time before the system 1 stops 86 feeding water to the flow channel 30.

In the example, the water temperature determination means 34 is preferably configured to measure a water temperature at or downstream of a water outlet 37 of the thick film heater 18 and to estimate the water temperature at or upstream of the water inlet 35 of the thick film heater 18 based on at least the measured temperature at or downstream of the water outlet 37.

In a preferred embodiment, the controller 36 is configured to control the thick film heater 18 during dispensing of one of the portions in dependence of a first water temperature which is estimated, by the water temperature determination means 34, based on at least a second water temperature at or downstream of the water outlet 37 which second water temperature is measured, by the water temperature determination means 34, during dispensing of one or more previous portions of the portions.

In a preferred embodiment, the system 1 is configured to receive a milk concentrate container 4, in particular of a bag-in-box type, for supplying milk concentrate to the milk concentrate inlet 33. To this end FIG. 2 shows the system 1 as comprising a housing part 40 for receiving a milk concentrate container 4. The milk concentrate container 4 is preferably provided with the mixing device 6 to which other parts of the system 1 can connect as shown in FIG. 1. Here the mixing device 6 comprises a section of the flow channel 30 which section includes the milk concentrate inlet 33.

In a preferred embodiment, the system comprises a valve actuator 38 for actuating a valve member 39 (see FIG. 1) of the received milk concentrate container 4, which valve member 39 during use regulates a flow of milk concentrate to the milk concentrate inlet 33, wherein the controller 36 is configured to control the valve actuator 38 for regulating the flow of milk concentrate.

In a preferred embodiment, the water temperature determination means 34 comprises a temperature sensor 34a, in particular a negative temperature coefficient NTC type thermistor, arranged at a water outlet 37 of the thick film heater 18. For example, the temperature sensor 34a can be connected to the controller 36 in various ways, for providing a sensor detection result (in particular water temperature) thereto, for example via a suitable (wired or wireless) communication line, as will be appreciated by the skilled person. For example, the sensor 34a can be integrated in a heater structure or heater assembly, or be separate from the heater (e.g., located at or near the water outlet 37 of the heater).

In the example, as explained elsewhere in this description with reference to FIG. 1, the hot milk-containing beverage component or beverage can comprise coffee, wherein the system 1 further comprises coffee dispensing means 3 for dispensing coffee for the portions.

FIG. 6 shows steps of exemplary method of dispensing a portion of a hot milk-containing beverage component or beverage. The method comprises: feeding 82 water through a flow channel 30; heating 81 the water in the flow channel 30 by a thick film heater 18; and feeding milk concentrate to the heated water in the flow channel 30. The method comprises determining 83, e.g., estimating and/or sensing, a water temperature at or upstream of a water inlet 35 of the thick film heater 18, and controlling 84 the heating by the heater 18 in dependence of the determined water temperature.

In the exemplary method, in a first heating mode the controlling 84 can be substantially independent of the determined temperature, wherein in a subsequent second heating mode the controlling 84 is dependent on the determined temperature.

In the example, the method preferably comprises powering down 85 the heater 18 while water flows through the heater 18.

In the example the determining 83 of the water temperature at or upstream of the water inlet 35 of the thick film heater 18 preferably comprises: sensing a water temperature at or downstream of a water outlet 37 of the thick film heater 18, for example during a dispensing of a previous portion of the hot milk-containing beverage component or beverage, and subsequently estimating the water temperature at or upstream of the water inlet 35 based on at least the sensed water temperature at or downstream of the water outlet 37.

To that end a water temperature determined, e.g., sensed, during dispensing of one portion may be stored 87 for subsequently determining 83, e.g., estimating, a water temperature for heater control 84 for a subsequent portion, e.g., an immediately subsequent portion.

The exemplary method can comprise actuating a valve member 39 of a milk concentrate container 4 for regulating the feeding of milk concentrate.

FIG. 6 shows steps of exemplary dispensing cycle for a beverage component or beverage according to the present example. The cycle can includes the steps of: receiving 80 an instruction, e.g. through a user interface, to dispense a next portion of the beverage component or beverage; activating 81 the heater 18; starting 82 to feed water through the flow channel 30; determining 83 a water temperature associated with the dispensing, e.g. an estimated and/or sensed water temperature at the inlet 35 and/or outlet 37 of the heater 18; controlling 84 the heater 18 in dependence of the determined water temperature; deactivating the heater 85 prior to stopping the feeding of water through the flow channel 30; stopping the feeding of water through the flow channel 30; and storing 88 a, e.g. the, determined water temperature associated with the present dispensing cycle for use in a subsequent dispensing cycle.

As indicated in FIG. 6, different subsequent phases can be distinguished in a dispensing cycle of the exemplary method, the phases including: a pre-heating phase P1; a feed-forward control phase P2; a feed-back control phase P3; and a deactivated heater phase P4. Hereafter the phases P1-P4 will be explained in more detail, wherein it will be appreciated that many variations to the described exemplary method are possible. Durations of the phases are controlled by the controller 36 as will be explained further, wherein in each phase the heater 18 is controlled by the controller 36 according to one or more rules and/or relationships, as will be appreciated by the skilled person in view of the present description.

The pre-heating phase P1 starts with activating 81 the heater 18, and ends with initial feeding 82 of water in the flow channel 30. The pre-heating phase P1 can promote that the heater 18 is at a relatively high temperature when water is initially fed 82 through the heater so that an initial part of the portion is sufficiently heated. During the pre-heating phase P1, the heater 18 is for example activated at a maximum available power level and/or at a predetermined fraction thereof.

The pre-heating phase P1 has a predetermined duration t_P1, which is for example dependent on one or more predetermined and/or estimated and/or measured values of a water temperature, a water flow rate, a heating power level and/or a heat capacity. Preferably the duration t_P1 is further predetermined by imposing a minimum duration, e.g., of 1 s, and/or a maximum duration, e.g., of 4 s.

Optionally the pre-heat phase P1 can be omitted, i.e., its duration t_P1 can be set to zero, for example when it is determined that pre-heating is not necessary, e.g., when a user interrupted a dispensing of an immediately previous portion.

During the pre-heating phase P1 the water pump 16 or an air pump (not shown) can optionally be activated to build up initial water pressure, or air pressure respectively, without starting water flow. In this way, also acoustic feedback can be provided to a user to signal that a dispensing cycle has been initiated.

The feed-forward control phase P2 preferably starts with initial feeding 82 of water in the flow channel 30 to start dispensing of a portion, and ends when the heater 18 is subsequently controlled 84 in dependence of the determined temperature in the feed-back control phase P3. During the feed-forward control phase P2 water is fed through the flow channel whereby that it can reach and influence the water temperature sensor 34a at the outlet 37 of the heater 18. Subsequent feed-back control in phase P3 is thereby enabled.

During the feed-forward control phase P2, the heater 18 is preferably intermittently powered according to a predetermined feed-forward duty cycle factor FFDC, which is for example dependent on one or more predetermined and/or estimated and/or measured values of a water temperature, a water flow rate, a heating power level and/or a heat capacity. It will be appreciated that, if necessary, the factor FFDC is further predetermined by imposing a minimum, e.g., of zero, and/or a maximum, e.g., of one.

The feed-forward control phase P2 has a predetermined duration t_P2, which is for example dependent on one or more predetermined and/or estimated and/or measured values of a water temperature, a water flow rate, a heating power level and/or a heat capacity. A minimum duration, e.g., of zero, and/or a maximum duration, e.g., of 3 s, can be imposed.

The feed-back control phase P3 starts when the heater 18 is controlled 84 in dependence of the determined temperature, and ends when the heater 18 is deactivated 85.

During the feed-back control phase P3, the heater 18 is preferably controlled according to a dynamic feed-back duty cycle FBDC which depends on a difference between a water temperature T_out at the water outlet 37 of the heater 18. The temperature T_out is preferably based on a temperature sensed by a temperature sensor 34a at the water outlet 37, optionally corrected for an estimated water temperature T_in_est at the inlet 35 of the heater 18. The feed-back control can be configured according to a proportional-integral (PI) and/or proportional-integral-derivative (PID) control loop mechanism. Such a feed-back control configuration can in particular impose a dynamic feed-back based correction to the feed-forward control scheme which can otherwise be continued from the feed-forward control phase P2. Thus, a feed-forward component can be present in the heater control in both phases P2 and P3, whereas a feed-back component is present only in the phase P3. Thus, the feed-back duty cycle FBDC in phase P3 can depend on the feed-forward duty cycle FFDC of phase P2.

The duration t_P3 of the feed-back control phase P3 primarily depends on a predetermined dispensing time of the portion, which may depend on a flow rate and a desired portion volume. The duration t_p3 may be determined by subtracting a predetermined duration t_P4 of the deactivated heater phase P4 from a predetermined total (remaining) dispensing duration.

The deactivated heater phase P4 preferably starts when the heater 18 is deactivated, and ends when feeding water in the flow channel is stopped 86, thereby ending the dispensing of a portion.

The duration t_P4 of the deactivated heater phase P4 can for example depend on one or more predetermined and/or estimated and/or measured values of a water temperature, a water flow rate, a heating power level and/or a heat capacity. A minimum duration, e.g., of 0.5 s, and/or a maximum duration, e.g., of 2 s, can be imposed in further predetermining the duration t_P4.

An effective maximum heating power level P_est can be estimated during one, e.g., each, dispensing cycle, i.e., for each dispensed portion, to be used for calculating a duty cycle and/or a phase duration as described above in a subsequent, e.g., an immediately subsequent, dispensing cycle.

The power level P_est can be estimated based e.g., on a record of one or more estimated and/or measured values of a temperature and/or a phase duration. The power level P_est for a dispensing cycle can be further predetermined by applying a low-pass filter on a time series which besides the newly estimated power level value includes previously predetermined values of the power level P_est for previous dispensing cycles. If needed an initial value for P_est can be set, e.g., at 2500 W.

The thus determined power level P_est can be stored, see step 87 in FIG. 6, for use in a subsequent dispensing cycle.

As alluded to above, a water temperature T_in_est at the inlet 35 of the heater 18 can be estimated during one, e.g., each, dispensing cycle, i.e., for each dispensed portion, to be used for calculating a duty cycle and/or a phase duration as described above in a subsequent, e.g., an immediately subsequent, dispensing cycle.

The water temperature T_in_est can be estimated based on for example one or more predetermined and/or estimated and/or measured values of a water temperature, a water flow rate, a heating power level and/or a heat capacity.

The inlet water temperature T_in_est can be further determined by imposing a minimum value, e.g., of 10° C., and/or a maximum value, e.g., of 40° C.

If the feed-back control phase P3 was shorter than a predetermined minimum duration, updating the estimate of the inlet water temperature T_in_est can be skipped, i.e., a previous value of the estimate can be maintained. If needed the value of the estimate T_in_est can be initialized, e.g., at about 23° C.

The thus estimated value of the inlet water temperature T_in_est can be stored, see step 88 in FIG. 6, and subsequently used as described above for a subsequent dispensing cycle.

Alternatively or additionally to estimating the water temperature at the inlet 35 of the heater 18 as described, a respective water temperature sensor (not shown) can be provided at the water inlet 35 of the heater 18 to determine a water temperature at said water inlet 35.

With reference to the drawings, the present description discloses an exemplary use of a thick film heater 18 for heating water intermittently flowing through a flow channel 30 which water is mixed with a milk concentrate downstream of the heater 18, whereby hot milk is formed for dispensing portions of a hot milk-containing beverage component or beverage.

With reference to the drawings, the present description discloses an exemplary system 1 for intermittently dispensing portions of a hot milk-containing beverage component or beverage, the system preferably comprising a flow channel 30 extending from a water inlet 31 to a dispensing outlet 32, the flow channel 30 being provided with a milk concentrate inlet 33 upstream of the dispensing outlet 32 and a thick film heater 18 upstream of the milk concentrate inlet 33, wherein the system 1 comprises water temperature determination means 34 configured to determine, e.g. estimate and/or measure, a property, in particular a temperature, of water in the flow channel 30, wherein the system 1 includes a controller 36 configured to control the thick film heater 18, wherein in a first heating mode the controlling by the controller 36 is substantially independent of the determined property, wherein in a subsequent second heating mode the controlling by the controller 36 is dependent on the determined property.

Also, with reference to the drawings, the present description discloses an exemplary system 1 for intermittently dispensing portions of a hot milk-containing beverage component or beverage, the system preferably comprising a flow channel 30 extending from a water inlet 31 to a dispensing outlet 32, the flow channel 30 being provided with a milk concentrate 33 inlet upstream of the dispensing outlet 32 and a thick film heater 18 upstream of the milk concentrate inlet 33, wherein the system 1 is configured to power down the thick film heater 18 at a predetermined heater deactivation time before the system 1 stops feeding water to the flow channel 30.

Further, with reference to the drawings, the present description discloses an exemplary method of dispensing a portion of a hot milk-containing beverage component or beverage, preferably comprising: feeding 82 water through a flow channel 30; heating 81 the water in the flow channel by a thick film heater 18; and feeding milk concentrate to the heated water in the flow channel 30, wherein the method comprises determining 83, e.g. estimating and/or sensing, a property, in particular a temperature, of the water, and controlling the heating, wherein in a first heating mode the controlling is substantially independent of the determined property, wherein in a subsequent second heating mode the controlling 84 is dependent on the determined property.

Furthermore, with reference to the drawings, the present description discloses an exemplary method of dispensing a portion of a hot milk-containing beverage component or beverage, preferably comprising: feeding 82 water through a flow channel 30; heating 81 the water in the flow channel 30 by a thick film heater 18; and feeding milk concentrate to the heated water in the flow channel 30, wherein the method comprises powering down 85 the heater 18 while water flows through the heater 30.

It is self-evident that the invention is not limited to the above-described exemplary embodiments. Various modifications are possible within the framework of the invention as set forth in the appended claims.

For example, various system parts can be arranged in various ways with respect to each other. As an example, a water flow meter can be arranged upstream or downstream of a respective pump (providing a water flow which is the be measured by the flow meter), as will be appreciated by the skilled person.

1. A system for intermittently dispensing portions of a hot milk-containing beverage component or beverage, comprising a flow channel extending from a water inlet to a dispensing outlet, the flow channel being provided with a milk concentrate inlet upstream of the dispensing outlet and a thick film heater upstream of the milk concentrate inlet, the milk concentrate inlet optionally being configured for feeding milk concentrate to heated water flowing through the flow channel, wherein the system comprises:
(a) a water temperature determination device configured to determine a water temperature at or upstream of a water inlet of the thick film heater; and
(b) a controller configured to control the thick film heater in dependence of a water temperature determined by the water temperature determination device.

2. The system according to claim 1, wherein the water temperature determination device is configured to measure a water temperature at or downstream of a water outlet of the thick film heater, and/or
wherein the water temperature determination device is configured to estimate the water temperature at or upstream of the water inlet of the thick film heater based on at least the measured temperature at or downstream of the water outlet.

3. The system according to claim 1, wherein in a first heating mode the controlling by the controller is substantially independent of the determined temperature, wherein in a subsequent second heating mode the controlling by the controller is dependent on the determined temperature.

4. The system according to claim 1, configured to power down the thick film heater at a predetermined heater deactivation time before the system stops feeding water to the flow channel.

5. The system according to claim 1, wherein the controller is configured to control the thick film heater during dispensing of one of the portions in dependence of a first water temperature which is determined by the water temperature determination device, based on at least a second water temperature at or downstream of the water outlet, which second water temperature is measured by the water temperature determination device during dispensing of one or more previous portions of the portions.

6. The system according to claim 1, wherein the system is configured to receive a milk concentrate container for supplying milk concentrate to the milk concentrate inlet and wherein the hot milk-containing beverage component or beverage optionally comprises coffee and the system further comprises a coffee dispenser for dispensing coffee for the portions.

7. The system according to claim 6, comprising a valve actuator for actuating a valve member (39) of the received milk concentrate container (4), which valve member (39) during use regulates a flow of milk concentrate to the milk concentrate inlet (33), wherein the controller (36) is configured to control the valve actuator (38) for regulating the flow of milk concentrate.

8. The system according to claim 1, wherein the water temperature determination device comprises a temperature sensor arranged at a water outlet of the thick film heater.

9. The system according to claim 8, wherein the temperature sensor is a negative temperature coefficient (NTC) type thermistor.

10. A method of dispensing a portion of a hot milk-containing beverage component or beverage, comprising:
(i) feeding water through a flow channel;
(ii) heating the water in the flow channel by a thick film heater; and;
(iii) feeding milk concentrate to the heated water in the flow channel,
wherein the method comprises determining a water temperature at or upstream of a water inlet of the thick film heater, and controlling the heating by the heater in dependence of the determined water temperature.

11. The method according to claim 10, wherein the determining of the water temperature at or upstream of the water inlet of the thick film heater comprises:
(a) sensing a water temperature at or downstream of a water outlet of the thick film heater, optionally during a dispensing of a previous portion of the hot milk-containing beverage component or beverage, and, optionally, subsequently
(b) estimating the water temperature at or upstream of the water inlet based on at least the sensed water temperature at or downstream of the water outlet.

12. The method according to claim 10, wherein in a first heating mode the controlling is substantially independent of the determined temperature, and wherein in a subsequent second heating mode the controlling is dependent on the determined temperature.

13. The method according to claim 10, further comprising powering down the heater while water flows through the heater.

14. A method of dispensing a portion of a hot milk-containing beverage component or beverage, comprising:
(a) feeding water through a flow channel;
(b) heating the water in the flow channel by a thick film heater; and
(c) feeding milk concentrate to the heated water in the flow channel,
wherein the method comprises powering down the heater while water flows through the heater.
